(19) United States
(12) Patent Application Publication
(10) Pub. No.: US 2017/0134931 A1
(43) Pub. Date: May 11, 2017

(54) METHOD FOR ACTIVATING A SUBSCRIBER CARD SUCH AS A SIM CARD

(71) Applicant: ORANGE, Paris (FR)

(72) Inventors: Yunus Arslan, Caen (FR); Aymeric De La Forest Divonne, Carpiquet (FR)

(21) Appl. No.: 15/317,460

(22) PCT Filed: Jun. 16, 2015
(86) PCT No.: PCT/FR2015/051596

§ 371 Date: Dec. 9, 2016

(30) Foreign Application Priority Data
Jun. 20, 2014 (FR) 1455741

(51) Int. Cl. H04W 8/18; H04W 12/06; H04W 4/00

(52) U.S. Cl. CPC H04W 8/183; H04W 4/008; H04W 12/06; H04W 88/06

(57) ABSTRACT

The invention pertains to a method for activating a subscriber card (SIM1), termed the first card, coupled to a first terminal (TRM1) able to communicate with a second terminal (TRM2) coupled to a second active subscriber card (SIM2). The terminals are able to communicate with a first network (NET) of an operator, a terminal being able to communicate with this first network only if the associated card is active. The terminals can furthermore communicate with one another via a second short-range network (SRN). The method is characterized in that it comprises at the level of the first terminal, when a communication is possible between the two terminals via the second network, a step of transmitting to the second terminal a request for activation of the first card on the first network, the request including the identifier of the first card.

### TECHNICAL FIELD

The field of the invention is that of radiocommunications and more particularly of radiocommunication terminals, such as radiotelephones.

The invention pertains to a method for activating a subscriber card of SIM card type (the initials standing for “Subscriber Identity Module” in English), USIM card type (the initials standing for “Universal Subscriber Identity Module” in English), or similar cards.

### PRIOR ART

For the sake of simplification of the description, throughout the rest of this document, the description will be limited to the particular case where the radiocommunication terminal is a GSM terminal comprising a SIM card. The person skilled in the art will extend this teaching without difficulty to any other type of radiocommunication terminal and SIM cards which operate in a similar manner. Conventionally, a GSM radiocommunication terminal may not access the services of the GSM network without a SIM card. Indeed, a SIM card is a module comprising all the data relating to the subscriber, namely an identity number IMSI (for “International Mobile Subscriber Identity” in English), an authentication key Ki, as well as associated algorithms for authentication of the subscriber by the GSM network.

A change of SIM card is possible for example following a change of terminal.

Activation of the new SIM card requires exchanges between the cards and the telecommunication operator that manages the cards. The aim of these exchanges is to modify a correspondence between the IMSI identifier of the card and an MSISDN number (the initials standing for “Mobile Station ISDN Number” in English) allotted to the card.

It is considered hereinafter that the terminal which includes the SIM card to be activated corresponds to the first terminal and to the first SIM card; and that the terminal which includes the already activated SIM card corresponds to the second terminal and to the second SIM card. Let us also consider that the first card comprises an identifier IMSI1 and the second card an identifier IMSI2.

The modifications to be made envisaged hereinabove consist in modifying a correspondence between an IMSI identifier and an MSISDN number in such a way that, following the modification, the first identifier IMSI1 corresponds to the MSISDN number instead of the second identifier IMSI2.

The main steps related to the activation of the first SIM card are the following:

During a first step, the user enters on the second terminal a call number of a voice server; the second terminal being at this juncture the only terminal out of the two terminals considered to be able to communicate with the network.

Once the communication has been established between the second terminal and the server, the latter requests input of the first identifier IMSI1 which corresponds to the first SIM card to be activated.

The user enters the identifier IMSI1, for example on the keypad of the second terminal, and instructs the dispatching of this identifier to the server.

On reception of the code, the server confirms the reception of the code and carries out the modification in the manner indicated hereinabove.

Following the confirmation, in our example, the user turns off the second terminal; and thereafter turns on the first terminal; in parallel, the operator replaces the IMSI2 by the IMSI1 in such a way that the IMSI1 corresponds to the MSISDN number. At this juncture the first card SIM1 is activated since a correspondence between its identifier IMS1 and the MSISDN is effective on the network; this first card is therefore usable by the first terminal TRM1 to access the network.

The operations carried out hereinabove by the user are sources of errors in particular for the non-technophile user. Moreover, a malicious third party could pass itself off as a card to be activated unbeknown to the user of the second terminal.

The invention improves the situation.

### THE INVENTION

The invention pertains to a method for activating a subscriber card, termed the first card, coupled to a first terminal able to communicate with a second terminal coupled to a second active subscriber card, the terminals being able to communicate with a first network of an operator, a terminal being able to communicate with this first network only if the associated card is active, the terminals being able furthermore to communicate with one another via a second short-range network, characterized in that it comprises at the level of the first terminal, when a communication is possible between the two terminals via the second network, a step of transmitting to the second terminal a request for activation of the first card, the request including the identifier of the first card.

The second terminal plays a role of trusted intermediary between the first card to be activated and the operator. This results in both a secure link between the two terminals owing to the use of a short-range network; and a secure link between the second terminal and the operator owing to the relationship of trust that the operator sustains with a terminal into which is inserted a subscriber card that it manages and that it can authenticate.

The automation of the exchanges and the easing of the tasks to be performed for the activation of the first card on the first network simplify the activation method. The user experience can therefore only be positive.

According to a particular mode of implementation of the invention, following the coupling between the first card and the first terminal, the first terminal emits, for example in the guise of request for activation or as a supplement to the request for activation, a signal representative of the existence of an inactive SIM card. A module present on the first terminal is able to detect the coupling and thereafter to request the emission of the signal. This avoids the first terminal having to emit a signal without it being necessary; this results in lower electrical consumption. In other words, the first terminal emits this signal only if it is coupled to an inactive card.

By virtue of the invention, the user is no longer constrained to enter a server's number to request an activation. Indeed, the emission of an item of information representative of the existence of an inactive card automatically triggers a series of actions, namely the dispatching to the second terminal of a request for activation, and the automatic establishment of a communication between the second terminal and the server with a view to an activation.

According to a particular mode of implementation of the invention, the step of transmitting the identifier to the second terminal is preceded by a step of receiving from the second terminal an agreement for the implementation of validation of the activation. This validation originates for example from a user action on the second terminal; this action being representative of an agreement of validation of the activation. The user of the first terminal can also confirm his wish to carry out the activation by transmitting a confirmation message. An activation is therefore not performed unbeknown to the user.

In our example, the second card stores an identifier, termed the second identifier. In this configuration, according to a second particular mode of implementation of the invention, which will be able to be implemented alternatively or cumulatively with the previous mode of implementation, the identifiers of the first and of the second card are verified before activation of the first card. This makes it possible to ensure the implementation of the method of activation between authorized cards. The verification is for example performed by a verification module of the network of a manager operator dealing with the subscriber cards. The place of the verification is therefore secure because executed by an entity, namely the operator, that manages the activation on the network.

According to yet another particular mode of implementation of the invention, which will be able to be implemented alternatively or cumulatively with the previous modes of implementation, following reception of the request for activation by the second terminal, the second terminal prevents use of the second card for access to the network. This allows the operator at one and the same time not to receive any communication on the part of the cards concerned in an activation; and to update its database with the new correspondence between the first identifier IMS1 and a number MSISDN2. Preventing use of the second card can consist of provision of an item of information to be retrieved on the second terminal. The item of information can be a message display on a screen of the second terminal; message indicating for example that the terminal must not be used during a given time span. Preventing use can also consist of the emission of a command able to power down the first terminal. The description which follows will give other possible variants.

According to a hardware aspect, the invention also relates, in the guise of product obtained directly by its implementation, to an activation request carrier signal generated during the implementation of a method in accordance with the preceding description.

According to another of its hardware aspects, the invention also relates to a terminal, termed the first terminal, able to be coupled to an inactive subscriber card, termed the first card, the terminal being able to communicate with a second terminal coupled to a second active subscriber card, the terminals being able to communicate with a first network, a terminal being able to communicate with this first network only if the associated card is active, the communication between the terminals being able to be performed by way of a second short-range network, characterized in that the terminal comprises a transmission module able to transmit, when a communication is possible between the terminals, a request for activation of the first card via the second network, the request including the identifier of the first card.

According to another hardware aspect, the invention also relates to a computer program comprising code instructions which, when it is executed by a processor, carries out the steps of the above-defined activation method. Such a program can use any programming language. It can be downloaded from a communication network and/or recorded on a computer readable medium.

According to another hardware aspect, the invention also relates to a data medium on which at least one series of program code instructions for the execution of the method such as defined hereinabove has been stored.

According to another functional aspect, the invention relates to a method for managing an activation of a subscriber card, termed the first card, coupled to a first terminal, termed the first terminal, by a second terminal coupled to a second subscriber card, the terminals being able to communicate with a first network, a terminal being able to communicate with this first network only if the associated card is active, the communication between the terminals being able to be performed furthermore by way of a second short-range network, characterized in that it comprises at the level of the second terminal, when a communication is possible between the two terminals,

a. a step of receiving a first request for activation arising from the first terminal including the identifier of the first card,

b. a step of transmitting a second request for activation of the first card, to the first network, for the activation of the first card on the first network.

According to another hardware aspect, the invention relates to a computer program able to be implemented on a terminal, the program comprising code instructions which, when it is executed by a processor, carries out the above-defined steps of the communication method.

According to another hardware aspect, the invention relates to a terminal, termed the second terminal, able to be coupled to a subscriber card, termed the second card, the terminal comprising a communication module able to communicate with a first network, and with another terminal, termed the first terminal, by way of a second short-range network (SRN), said first terminal being able to be coupled to an inactive subscriber card (SIM1), a terminal being able to communicate with the first network only if the associated card is active, characterized in that it comprises,
a. A reception module able to receive from the first network a first request for activation arising from the first terminal including the identifier of the first card,
b. A transmission module able to transmit a second request for activation of the first card, to the first network, for the activation of the first card.

According to a particular mode of implementation of the invention, the terminal a module for establishing a communication with a server following reception of a request for activation. The communication can be effected directly following reception of the request for activation or indirectly for example after reception of a confirmation of the wish to activate the first card received from the first terminal.

Finally, according to another hardware aspect, the invention pertains to a data medium on which at least one series of program code instructions for the execution of a communication method defined hereinabove has been stored.

The invention will be better understood on reading the description which follows, given by way of example and with reference to the appended drawings in which:

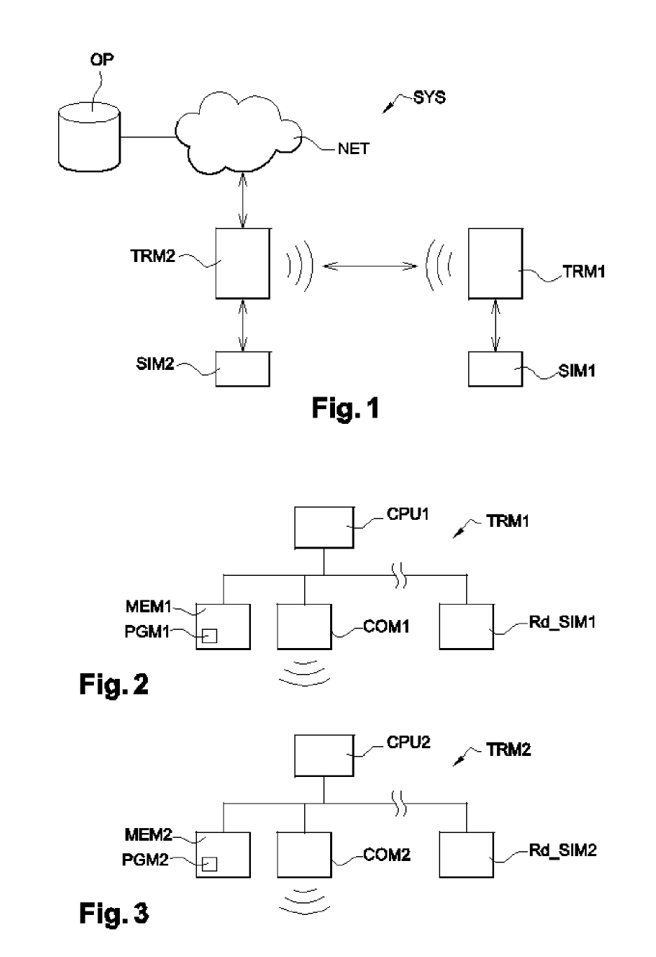

FIG. 1 represents a computing system on which an exemplary embodiment of the invention is illustrated.

FIGS. 2 and 3 represent the circuits of the various equipment involved in the method of the invention.

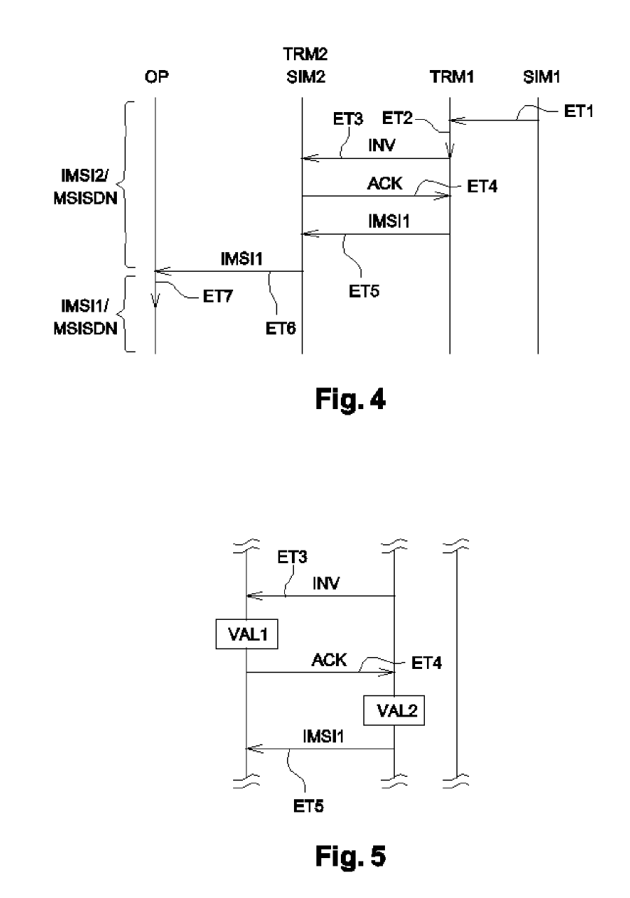

FIG. 4 is a schematic view of the exchanges between terminals, SIM cards and operator, illustrating an embodiment of the invention.

FIG. 5 is a schematic view of possible variants to the embodiment which is described with reference to FIG. 4.

### DETAILED DESCRIPTION OF AN EXEMPLARY EMBODIMENT ILLUSTRATING THE INVENTION

FIG. 1 represents a system SYS comprising terminals TRM1 and TRM2 coupled to respective subscriber cards SIM1 and SIM2.

The terminals communicate with one another via one or more networks NET managed by respective operators. In our example, in order to simplify the account of the invention, a single operator OP manages the cards SIM1 and SIM2. Different operators could also manage the cards; in this case, the data relating to the subscribers must be pooled for the implementation of the invention.

Let us recall that a SIM card is a chip card fabricated by fitting an integrated circuit into a module which is linked to a communication interface. This module is generally inset, that is to say placed in a cavity made in the card body. The integrated circuit forming the chip of the chip card is a secure component able to communicate solely with a corresponding card reader. The communication interface can be a contact interface. In this case, the card generally comprises metallizations flush with the surface of the card, disposed at a precise location of the card body. These metallizations are intended to come into contact with a reading head of a reader with a view to electrical transmission of data. The communication interface can also be a contactless interface. In this case, the card generally comprises an antenna making it possible to exchange information by radiofrequency with an exterior reader. Thus, the chip card communicates with an associated reader when the chip card is brought into proximity with the reader. More precisely, the reader transmits signals by virtue of its antenna and when the chip card is situated in a radius of detection of the reader, its antenna detects the signals emitted by the reader. Data can then be transmitted between the chip card and the contactless reader.

There also exist hybrid cards which comprise at one and the same time metallizations flush with the surface of the card and an antenna in the card body. This type of card can therefore exchange data with the exterior either in contact mode, or in contactless mode.

In our example, the communication interface is a contact interface.

The SIM card stores data, especially identity data which are necessary for communicating with the network NET. These data include especially an IMSI (International Mobile Subscriber Identity) identifier; this identifier allows the routing of telephone calls, messages (SMS/MMS) and data in the network. This identifier is stored in the SIM card. It is also stored in an HLR (Home Location Register) register of the operator. In a general manner, this identifier is not modified as long as the subscriber remains with the same operator. This identifier is made up of 3 groups of codes, namely an MCC (Mobile Country Code) code, an MNC (Mobile Network Code) code and an MSIN (Mobile Subscriber Identification Number) number. For example, MCC=208 for metropolitan France, MNC=01 for the operator concerned, MSIN=10-digit number in France, but which has nothing to do with the call number.

The card contains other data which will not be described hereinafter as it is of no relevance to the account of the invention.

To an IMSI identifier there corresponds an MSISDN (Mobile Station ISDN Number) number. The latter is the call number in the international format (E.g.: 33612345678). This number allows incoming calls and messages (SMS/MMS) to be routed as far as the HLR register of the operator concerned. Once the incoming call or message has been routed as far as the HLR of the operator by virtue of the MSISDN number, the IMSI takes over so that the call arrives at the terminal depending on the place where you the terminal is situated on the network.

This IMSI identifier is made up of three groups of code, namely a “Country Code” code, a “National Destination Code” code and a “Subscriber Number” number. For example, an MSISDN has the following form: 33612345678 which is made up of 3 groups of data to have 33 (country code for France), 612 (span of numbers allotted initially to the operator) and 345678.

With reference to FIGS. 2 and 3, the terminals TRM1 and TRM2 are equipped with processors CPU1 and CPU2 respectively.

The terminals are furthermore equipped
with card readers Rd-SIM1 and Rd-SIM2,
with memories MEM1 and MEM2 including modules illustrated by means of computer programs PGM1 and PGM2 for the implementation of the invention,
with short-range wireless communication modules COM1 and COM2, respectively.

A short-range network refers here to a network having limited distance coverage. In this context, by virtue of their respective communication modules, the terminals can communicate data under a given distance. Ideally, this is so as to guarantee a secure linkup between the two terminals. The coverage of this short-range network is chosen in such a way that a possible communication between two terminals by way of this network will be evidence of a proximity between the two terminals in question and implicitly a proximity of the user in relation to the two terminals. This short-range network is for example an RFiD (Radio Frequency Identification) network, a Bluetooth network. This network can also consist of a visual code generator and of a picture-taking device which is capable of taking a picture of the code and of extracting an item of information therefrom. A sound capture device, or a light emitter can also be used as emitter of signals, the code being emitted in the form of a sound or of light, respectively.

Let us recall that the first card SIM1 is inactive and that the sought-after aim is its activation. For the activation of the first card SIM1, the second terminal TRM2 plays the role of relay between the first terminal and the operator of the network that will manage the activation.

The first program PGM1 and the second PGM2 will cooperate so as to achieve the envisaged aim.

FIG. 4 is an algorithm illustrating a sequence of steps of an embodiment. The steps of this embodiment are as follows:

During a first insertion step ET1, the first card SIM1 is inserted into the first terminal TRM1.

In our example, during a second step ET2, following the insertion, a command is transmitted to the first program PGM1. The function of the command is the execution of the first program PGM1 by the first processor CPU1. This step is optional since the first program can be permanently active and therefore ready to receive a command.

Following its execution, in our example, the first program PGM1 emits a signal on the short-range network so as to notify the terminals that are situated in the radio field of the short-range network that an inactive card is present. In our example, this signal will cease on completion of the activation of the first SIM card; this allows the terminal to avoid having to emit a notification signal of this type whilst the card with which it is coupled is activated.

In our example, it is assumed that only the second terminal TRM2 is situated in the radius of coverage of the first terminal TRM1.

During a third subsequent step ET3, the second terminal TRM2 receives the signal emitted by the first terminal TRM1.

On reception of the signal, the second processor CPU2 executes the second program PGM2. In our example, following reception of the signal, the second terminal TRM2 emits to the first terminal an acknowledgment signal ACK during a fourth step ET4. The function of this signal is to inform the first terminal TRM1 of the presence of the second terminal TRM2 in the radio field of the first terminal TRM1.

Following reception of the acknowledgment signal ACK, during a fifth step ET5, the first terminal TRM1 transmits to the second terminal TRM2 a request for activation signal, termed the first request for activation, including in our example the code IMSI1 or more generally a code representative of the identifier IMSI1 which could be interpreted in respect of the obtaining of the code IMSI1.

In our example, the first terminal TRM1 recovers the first identifier IMSI1 for example by way of a Simtoolkit application, known to the person skilled in the art, present in the card SIM1. This Simtoolkit application allows a communication between the terminal and the card. Reference may be made to the following ETSI standard (3 GPP TS 51.014 (ETSI GSM 11.14) for the cards or 3 GPP TS 31.111) for more details. The first terminal TRM1 can also recover the first identifier IMS1 via an API interface (the initials standing for “Application Program Interface” in English) of the operating system of the first terminal. More generally, the procedure for obtaining the identifier IMS1 is arbitrary.

During a sixth step ET6, the second terminal TRM2 transmits to the operator via the network NET a new request for activation, termed the second request, of the first card. The request includes the code IMS1 of the first card

The operator OP thereafter receives the request during a seventh step ET7. The operator then carries out an association between the code IMSI1 and the identifier of the second card SIM2 so as to activate the first card SIM1.

The second card SIM2 can thereafter be deactivated by the operator; accordingly the operator deletes the correspondence between the identifier IMSI2 of the second card SIM2 and the MSISDN number.

The exemplary embodiment described hereinabove can form the subject of several variants.

According to a first variant, the second terminal TRM2 also transmits its own identifier IMSI2 to the operator. This allows the operator to be sure that the identifiers IMSI1 and IMSI2 received correspond to cards of one and the same user. Accordingly, the operator has prior knowledge of the subscribers to whom the SIM cards are delivered. The knowledge in question can be linked with the data of the subscription contract.

According to a second variant, with reference to FIG. 5 (representing a part of FIG. 4 to which are added two steps VAL1 and VAL2) the fifth step ET5 is preceded by a step of validating VAL2 the transmission of the activation message. This allows the user to be sure that the recipient terminal of the request is indeed the second terminal TRM2 and not another terminal.

In the same manner as in the previous variant, still with reference to FIG. 5, the transmission of the acknowledgment in the third step ET3 can be conditioned to a validation VAL1 made by the user of the second terminal. This validation confirms the agreement of the user of the second terminal in respect of the implementation of the activation.

In a general manner, all data to be emitted from a card can be preceded by a validation by the emitter terminal.

According to another possible variant, the programs PGM1 and PGM2 are installed in the cards SIM1 and SIM2, respectively. Indeed, current SIM cards, as indicated previously, may be furnished with a contactless communication module. The exchanges described hereinabove between the third step and the fifth step ET5 are thus performed between cards directly. The first step ET1 described previously is for its part modified. In the present configuration, the insertion of the first card into the first terminal triggers the execution of the first program installed in the first card SIM1. The other steps described (ET6 and ET7) are the same as those described with reference to FIG. 4.

The switchover of correspondence between IMSI and MSISDN requires a service continuity phase in the course of which a single terminal can use the network. Thus, according to another variant, following reception of the request for activation by the second terminal, the second terminal (by implication the second program) notifies the request for activation in progress on its screen in such a way that the user does not use the second terminal for a given duration. The notification can be a message indicating that the second terminal must not be used for a given time span; up to the user to apply the setpoint.

Another way of ensuring service quality during switchover is to emit a command able to power down the first and/or the second terminal TRM1. This power-down is optionally followed by a command able to power up the first terminal again after a given duration which ideally corresponds at least to duration necessary for the switchover of correspondences by the operator and therefore the activation of the first card SIM1. Accordingly, the first terminal is for example equipped with a clock (timer) able to reboot the first terminal after a given duration.

Note that, in the present text, the term module can correspond either to a software component or to a hardware component or a set of hardware and software components, a software component itself corresponding to one or more computer programs or subprograms or in a more general manner to any element of a program able to implement a function or a set of functions such as described for the modules concerned. In the same manner, a hardware component corresponds to any element of a hardware set able to implement a function or a set of functions for the module concerned (integrated circuit, chip card, memory card, etc.).

1. A method for activating a subscriber card (SIM1), termed the first card, coupled to a first terminal (TRM1) able to communicate with a second terminal (TRM2) coupled to a second active subscriber card (SIM2), the terminals being able to communicate with a first network (NET1), a terminal being able to communicate with this first network only if the associated card is active, the terminals being able furthermore to communicate with one another via a second short-range network (SRN), characterized in that it comprises at the level of the first terminal, when a communication is possible between the two terminals via the second network, a step of transmitting (ET5) to the second terminal a request for activation of the first card on the first network, the request including the identifier of the first card.

2. The activation method as claimed in claim 1, characterized in that, following the coupling between the first card and the first terminal, the first terminal emits a signal representative of the existence of an inactive subscriber card.

3. The activation method as claimed in claim 1, characterized in that the step (ET5) of transmitting the identifier (IMSI1) to the second terminal is preceded by a step of receiving from the second terminal an agreement for the implementation of the validation of the activation.

4. The activation method as claimed in claim 1, characterized in that the second card (SIM2) stores an identifier (IMSI2), termed the second identifier, in that the identifiers of the first and of the second card are verified before activation of the first card.

5. The activation method as claimed in claim 4, characterized in that the verification is performed by a verification module of the network of a manager operator (OP) dealing with the subscriber cards (SIM1, SIM2).

6. The method as claimed in claim 1, characterized in that, following reception of the request for activation by the second terminal, the second terminal prevents use of the second card (SIM2).

7. A computer program (PGM1) able to be implemented on a terminal, the program comprising code instructions which, when executed by a processor, carries out a method for activating a subscriber card (SIM1), termed the first card, coupled to a first terminal (TRM1) able to communicate with a second terminal (TRM2) coupled to a second active subscriber card (SIM2), the terminals being able to communicate with a first network (NET1), a terminal being able to communicate with this first network only if the associated card is active, the terminals being able furthermore to communicate with one another via a second short-range network (SRN), characterized in that it comprises at the level of the first terminal, when a communication is possible between the two terminals via the second network, a step of transmitting (ET5) to the second terminal a request for activation of the first card on the first network, the request including the identifier of the first card.

8. A data medium on which at least one series of program code instructions for execution of a method has been stored, the method for activating a subscriber card (SIM1), termed the first card, coupled to a first terminal (TRM1) able to communicate with a second terminal (TRM2) coupled to a second active subscriber card (SIM2), the terminals being able to communicate with a first network (NET1), a terminal being able to communicate with this first network only if the associated card is active, the terminals being able furthermore to communicate with one another via a second short-range network (SRN), characterized in that it comprises at the level of the first terminal, when a communication is possible between the two terminals via the second network, a step of transmitting (ET5) to the second terminal a request for activation of the first card on the first network, the request including the identifier of the first card.

9. An activation request carrier signal generated during the implementation of a method in accordance with claim 1.

10. A terminal (TRM1), termed the first terminal, able to be coupled to an inactive subscriber card (SIM1), termed the first card, the terminal being able to communicate with a second terminal coupled to a second active subscriber card (S1M2), the terminals being able to communicate with a first network (NET1), a terminal being able to communicate with this first network only if the associated card is active, the communication between the terminals being able to be performed by way of a second short-range network (SRN), characterized in that the terminal comprises a transmission module able to transmit, when a communication is possible between the terminals, a request for activation of the first card via the second network, the request including the identifier of the first card.

11. A method for managing an activation of a subscriber card (SIM1), termed the first card, able to be coupled to a first terminal (TRM1), termed the first terminal, by a second terminal (TRM2) able to be coupled to a second subscriber card (SIM2), the terminals being able to communicate with a first network (NET), a terminal being able to communicate with this first network only if the associated card is active, the communication between the terminals being able to be performed furthermore by way of a second short-range network (SRN), characterized in that it comprises at the level of the second terminal, when a communication is possible between the two terminals,
a. a step of receiving from the second network a first request for activation arising from the first terminal including the identifier of the first card,
b. a step of transmitting a second request for activation of the first card, to the first network, for the activation of the first card.

12. A computer program (PGM2) able to be implemented on a terminal, the program comprising code instructions which, when it is executed by a processor, carries out a method for managing an activation of a subscriber card (SIM1), termed the first card, able to be coupled to a first terminal (TRM1), termed the first terminal, by a second terminal (TRM2) able to be coupled to a second subscriber card (SIM2), the terminals being able to communicate with a first network (NET), a terminal being able to communicate with this first network only if the associated card is active, the communication between the terminals being able to be performed furthermore by way of a second short-range network (SRN), characterized in that it comprises at the level of the second terminal, when a communication is possible between the two terminals,
a. a step of receiving from the second network a first request for activation arising from the first terminal including the identifier of the first card,
b. a step of transmitting a second request for activation of the first card, to the first network, for the activation of the first card.

13. A terminal (TRM2), termed the second terminal, able to be coupled to a subscriber card, termed the second card, the terminal comprising a communication module able to communicate with a first network (NET), and with another terminal, termed the first terminal, by way of a second short-range network (SRN), said first terminal being able to be coupled to an inactive subscriber card (SIM1), a terminal being able to communicate with the first network only if the associated card is active, characterized in that the second terminal comprises,
a. a reception module able to receive from the second network a first request for activation arising from the first terminal including the identifier of the first card (SIM1),
b. a transmission module able to transmit a second request for activation of the first card, to the first network, for the activation of the first card.

14. A terminal (TRM2) as claimed in claim 13, characterized in that it comprises a module for establishing a communication with a server following reception of a request for activation.

15. A data medium on which at least one series of program code instructions for execution of a method has been stored, the method for managing an activation of a subscriber card (SIM1), termed the first card, able to be coupled to a first terminal (TRM1), termed the first terminal, by a second terminal (TRM2) able to be coupled to a second subscriber card (SIM2), the terminals being able to communicate with a first network (NET), a terminal being able to communicate with this first network only if the associated card is active, the communication between the terminals being able to be performed furthermore by way of a second short-range network (SRN), characterized in that it comprises at the level of the second terminal, when a communication is possible between the two terminals,
a. a step of receiving from the second network a first request for activation arising from the first terminal including the identifier of the first card,
b. a step of transmitting a second request for activation of the first card, to the first network, for the activation of the first card.
